(19) United States
(12) Patent Application Publication
(10) Pub. No.: US 2015/0261543 A1
(43) Pub. Date: Sep. 17, 2015

(54) METHOD IN A PROCESSOR, AN APPARATUS AND A COMPUTER PROGRAM PRODUCT

(71) Applicant: Mika Lahteenmaki, Tampere (FI)

(72) Inventor: Mika Lahteenmaki, Tampere (FI)

(21) Appl. No.: 14/376,843

(22) PCT Filed: Mar. 21, 2012
(86) PCT No.: PCT/FI2012/050285

§ 371 Date: Oct. 7, 2014

(51) Int. Cl. G06F 9/38; G06F 15/80

(52) U.S. Cl. CPC G06F 9/3869; G06F 15/80

(57) ABSTRACT

There is disclosed a method in which a pipelining instruction is received by a first processor core of a multicore processor. Information in the pipelining instruction is used to determine a connection between a first functional unit in the first processor core and a second functional unit in a second processor core of the multicore processor. A switch is controlled to form a pipeline comprising the first functional unit and the second functional unit to enable data communication connection between an output of the first functional unit and an input of the second functional unit. The method may further comprise using a translation unit to translate an instruction of an instruction set of a first processor core to a corresponding instruction or a sequence of instructions of an instruction set of the second processor core. There is also disclosed an apparatus and a computer program product to implement the method.

### TECHNICAL FIELD

The present invention relates to a method comprising receiving instructions by a multicore processor comprising at least a first processor core and a second processor core. The present invention also relates to an apparatus comprising at least one multicore processor and at least one memory including computer program code, the at least one memory and the computer program code configured to, with the at least one multicore processor, cause the apparatus to receive instructions by the multicore processor comprising at least a first processor core and a second processor core. The present invention further relates to a computer program product including one or more sequences of one or more instructions which, when executed by one or more multicore processors, cause an apparatus to at least perform the following: receiving instructions by the multicore processor comprising at least a first processor core and a second processor core.

### BACKGROUND INFORMATION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In processors which contain two or more processor cores, i.e. multicore processors, different applications may be simultaneously run by different processor cores. It may also be possible to share the execution of an application between two or more processor cores of the multicore processor if all processor cores has the same instruction set.

Different processor cores of a multicore processor may implement similar instruction set or some or all of the processor cores may implement different instruction sets.

### SUMMARY OF SOME EXAMPLE EMBODIMENTS

In the following the term multicore processor relates to a processor which has two or more processor cores and the cores may have similar or different instruction sets. The term heterogeneous multicore processor relates to a multicore processor in which at least one processor core has at least partly different instruction set than another processor core of the multicore processor. In some embodiments each processor core of a heterogeneous multicore processor has at least partly different instruction set than the other processor cores.

In some applications which are implemented in an apparatus having a multicore processor, all the available processing power is not always needed and some of the processor cores of the multicore processor may be idle most of the time. For example, an apparatus may comprise a software defined radio (SDR) which is partly implemented by software and the software may comprise algorithms and programs for different purposes. For example, in the next generation mobile communications systems such as the Long Term Evolution (LTE), many parts of the communication device are implemented as software algorithms which are not needed all the time the communication device is operating. It may be possible to utilize this idle time by other applications and, for example, camera algorithms can be executed using the same processors. In some embodiments the camera algorithms can be executed efficiently in pipeline fashion.

In a heterogeneous multicore processor, at least some of the processor cores have different instruction sets which may make it challenging to do the scheduling efficiently. In some embodiments, the program codes may have been compiled to obtain different versions of binary code for each processor core that has a unique instruction set so that all processor cores could be utilized to run the application. This may mean that a lot of memory may be needed to store the binary codes of the application.

In some embodiments functional units of a processor core can be connected to functional units of other processor cores of the multicore processor to form a pipeline, in which the computation results of a previous functional unit are directly fed to the input of a next functional unit. The next functional unit may be in another processor core. The functional units can be used either as a part of the pipeline or like normal separate functional units.

If, for example, another process tries to use a functional unit, which is a part of an active pipeline, which is busy processing data, the instruction may be translated using a translation unit to a set of instructions, which can be executed on other functional units of the processor. In this way, the pipeline of functional units can be active while the processor is simultaneously serving processes which would need the units in the pipeline for their execution.

The pipeline can be formed in any order. In some embodiments one functional unit can only be once in the pipeline but in some other embodiments one functional unit may exist in multiple places in the pipeline, or there may be a loop in the pipeline wherein the same functional unit may operate in different phases of the pipeline. The pipeline may be formed by issuing a special command on each of those processor cores which are part of the pipeline. In the command, the input and output are specified to be for example a previous processor core and a next processor core. In the last processor core of the pipeline, the output may be specified to be, for example, a memory location, which stores the output of the pipeline. FIG. 1 illustrates an example of the pipeline architecture. There is a switch which connects the buses of the processor cores so that the pipeline can be formed. The switch may be programmed with a special command or commands.

The pipeline processing is started by issuing an instruction of the first functional unit of the pipeline. Instead of or in addition to the register or the memory location, the result of the instruction goes to the next functional unit in the pipeline.

According to a first aspect of the present invention there is provided a method comprising:
receiving a pipelining instruction by a first processor core of a multicore processor;
using information in the pipelining instruction to determine a connection between a first functional unit in the first processor core and a second functional unit in a second processor core of the multicore processor; and

controlling a switch to form a pipeline comprising the first functional unit and the second functional unit to enable data communication connection between an output of the first functional unit and an input of the second functional unit.

According to a second aspect of the present invention there is provided an apparatus comprising a processor and a memory including computer program code, the memory and the computer program code configured to, with the processor, cause the apparatus to:
receive a pipelining instruction by a first processor core of a multicore processor;
use information in the pipelining instruction to determine a connection between a first functional unit in the first processor core and a second functional unit in a second processor core of the multicore processor; and
control a switch to form a pipeline comprising the first functional unit and the second functional unit to enable data communication connection between an output of the first functional unit and an input of the second functional unit.

According to a third aspect of the present invention there is provided a computer program product including one or more sequences of one or more instructions which, when executed by one or more processors, cause an apparatus to at least perform the following:
receiving a pipelining instruction by a first processor core of a multicore processor;
using information in the pipelining instruction to determine a connection between a first functional unit in the first processor core and a second functional unit in a second processor core of the multicore processor; and
controlling a switch to form a pipeline comprising the first functional unit and the second functional unit to enable data communication connection between an output of the first functional unit and an input of the second functional unit.

According to a fourth aspect of the present invention there is provided an apparatus comprising:
a multicore processor comprising at least a first processor core and a second processor core;

an instruction fetcher adapted to receive a pipelining instruction by the first processor core of the multicore processor, wherein the first processor core is adapted to use information in the pipelining instruction to determine a connection between a first functional unit in the first processor core and a second functional unit in a second processor core of the multicore processor; and

a switch adapted to form a pipeline comprising the first functional unit and the second functional unit to enable data communication connection between an output of the first functional unit and an input of the second functional unit. According to a fifth aspect of the present invention there is provided an apparatus comprising:
means for receiving a pipelining instruction by a first processor core of a multicore processor;
means for using information in the pipelining instruction to determine a connection between a first functional unit in the first processor core and a second functional unit in a second processor core of the multicore processor; and
means for controlling a switch to form a pipeline comprising the first functional unit and the second functional unit to enable data communication connection between an output of the first functional unit and an input of the second functional unit.

Some embodiments of the present invention propose connecting functional units of different processor cores of a multicore processor to form a pipeline. Some embodiments of the present invention also propose translating an instruction of a first set of instructions to an instruction of a second set of instructions in a processor core before running executing the instruction.

### DESCRIPTION OF THE DRAWINGS

In the following the present invention will be described in more detail with reference to the appended drawings in which

FIG. 1 depicts as a block diagram an apparatus according to an example embodiment;

FIG. 2 depicts an example of some functional units of a processor core of a multicore processor;

FIG. 3a depicts as a block diagram a pipeline according to an example embodiment;

FIG. 3b depicts as a block diagram a pipeline according to another example embodiment;

FIGS. 4a-4d depict examples of time sliced operation of threads in a multicore processor;

FIG. 5 depicts an example of a translation unit of a processor core according to an example embodiment;

FIG. 6a is a flow diagram of an example of a method;

FIG. 6a is a flow diagram of another example of a method;

FIG. 7 is a flow diagram of yet another example of a method;

FIG. 8 shows schematically a user equipment suitable for employing some embodiments of the invention;

FIG. 9 depicts as a block diagram an apparatus according to an example embodiment of the present invention; and

FIG. 10 further shows schematically electronic devices employing embodiments of the invention connected using wireless and wired network connections.

### DETAILED DESCRIPTION OF SOME EXAMPLE EMBODIMENTS

The following describes in further detail suitable apparatus and possible mechanisms for the provision of improving operation of multicore processors.

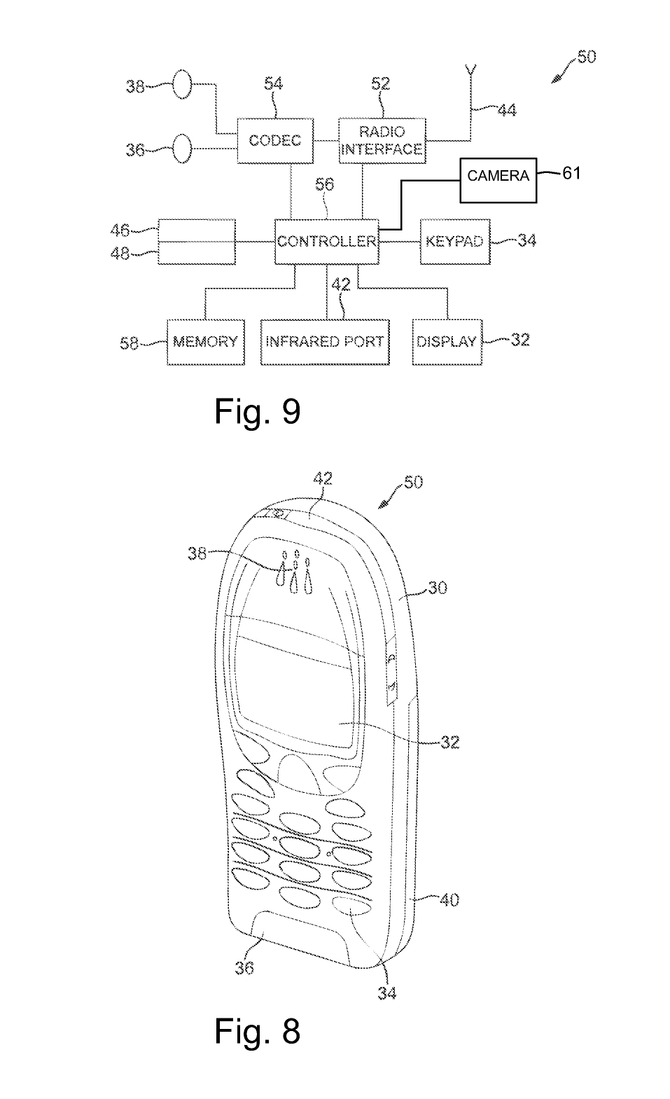

In this regard reference is first made to FIG. 8 which shows an example of a user equipment suitable for employing some embodiments of the present invention and FIG. 9 which shows a block diagram of an exemplary apparatus or electronic device 50, which may incorporate an apparatus according to an embodiment of the invention.

The electronic device 50 may for example be a mobile terminal or user equipment of a wireless communication system. However, it would be appreciated that embodiments of the invention may be implemented within any electronic device or apparatus which may comprise multicore processors.

The electronic device 50 may comprise a housing 30 for incorporating and protecting the device. The electronic device 50 further may comprise a display 32 in the form of a liquid crystal display. In other embodiments of the invention the display may be any suitable display technology suitable to display an image or video. The electronic device 50 may further comprise a keypad 34. In other embodiments of the invention any suitable data or user interface mechanism may be employed. For example the user interface may be implemented as a virtual keyboard or data entry system as part of a touch-sensitive display. The electronic device may comprise a microphone 36 or any suitable audio input which may be a digital or analogue signal input. The electronic device 50 may further comprise an audio output device which in embodiments of the invention may be any one of: an earpiece 37, speaker, or an analogue audio or digital audio output connection. The electronic device 50 may also comprise a battery 40 (or in other embodiments of the invention the device may be powered by any suitable mobile energy device such as solar cell, fuel cell or clockwork generator). The electronic device may further comprise an infrared port 42 for short range line of sight communication to other devices. In other embodiments the electronic device 50 may further comprise any suitable short range communication solution such as for example a Bluetooth wireless connection or a USB/firewire wired connection.

As shown in FIG. 9, the electronic device 50 may comprise one or more controllers 56 or one or more multicore processors for controlling the electronic device 50. The controller 56 may be connected to a memory 58 which in embodiments of the invention may store user data and/or other data and/or may also store instructions for implementation on the controller 56. The controller 56 may further be connected to codec circuitry 54 suitable for carrying out coding and decoding of audio and/or video data or assisting in coding and decoding possibly carried out by the controller 56.

The electronic device 50 may further comprise a card reader 48 and a smart card 46, for example a universal integrated circuit card (UICC) and a universal integrated circuit card reader for providing user information and being suitable for providing authentication information for authentication and authorization of the user at a network.

The electronic device 50 may comprise radio interface circuitry 52 connected to the controller 56 and suitable for generating wireless communication signals for example for communication with a cellular communications network, a wireless communications system or a wireless local area network. The electronic device 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the electronic device 50 comprises a camera 61 capable of recording or detecting individual frames which are then passed to the codec 54 or controller for processing. In some embodiments of the invention, the electronic device may receive the image data for processing from another device prior to transmission and/or storage. In some embodiments of the invention, the electronic device 50 may receive either wirelessly or by a wired connection the image for processing.

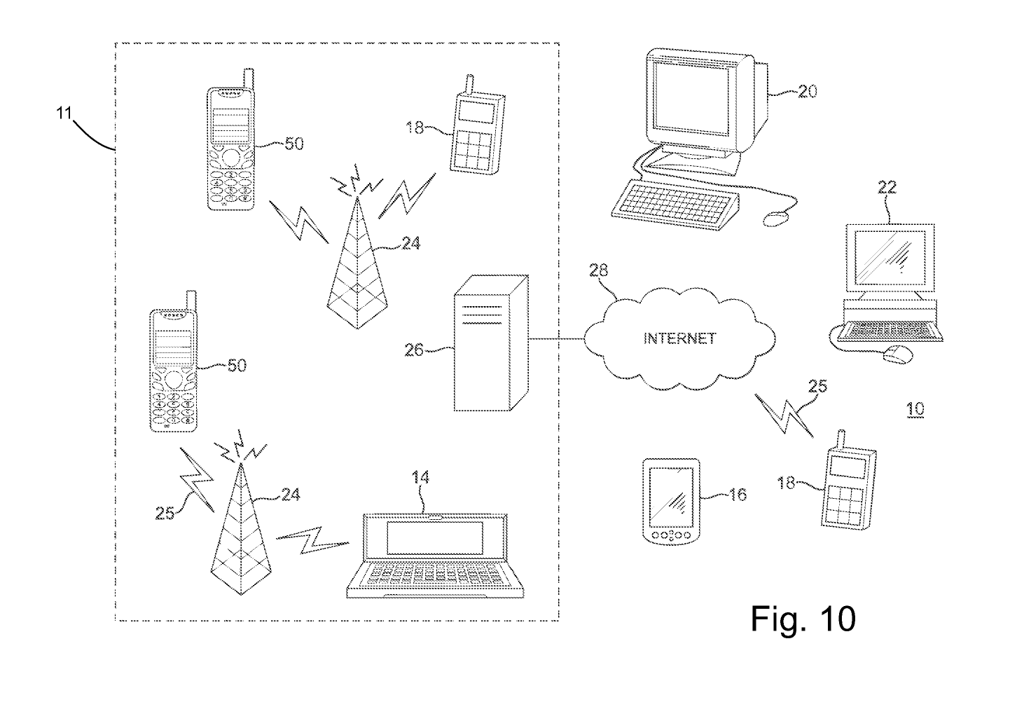

With respect to FIG. 10, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a Global System for Mobile communications (GSM), a

Universal Mobile Telecommunications System (UMTS), a Code Division Multiple Access (CDMA) network etc.), a wireless local area network (WLAN) such as defined by any of the Institute of Electrical and Electronics Engineers (IEEE) 802.x standards, a Bluetooth personal area network, an Ethernet local area network, a token ring local area network, a wide area network, and the Internet.

The system 10 may include both wired and wireless communication devices or electronic device 50 suitable for implementing embodiments of the invention.

For example, the system shown in FIG. 10 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The electronic device 50 may be stationary or mobile when carried by an individual who is moving. The electronic device 50 may also be located in a mode of transport including, but not limited to, a car, a truck, a taxi, a bus, a train, a boat, an airplane, a bicycle, a motorcycle or any similar suitable mode of transport.

Some or further apparatuses may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access

(CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

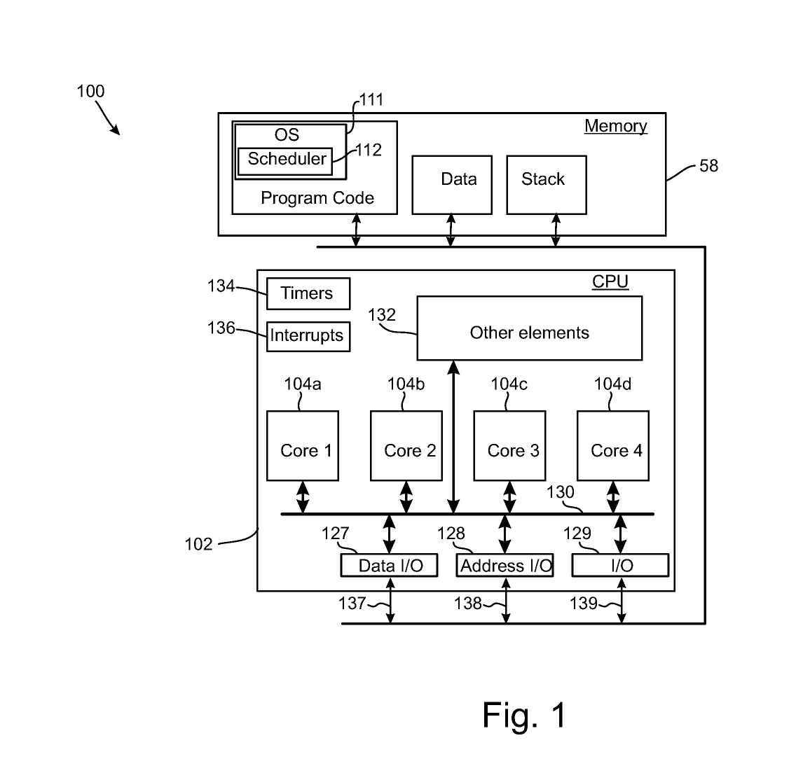

FIG. 1 depicts in more detail an example of an apparatus 100 in which the present invention may be utilized. The apparatus 100 may be a part of the electronic device 50 or another device. For example, the apparatus 100 may be part of a computing device such as the desktop computer 20.

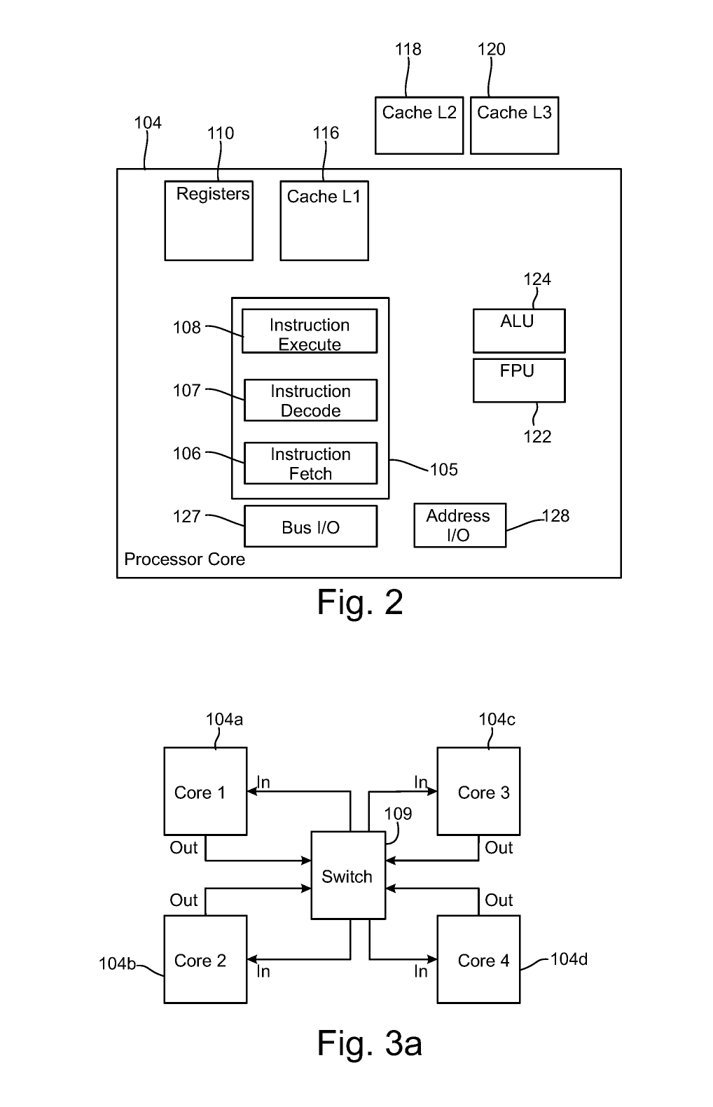

The apparatus 100 comprises a multicore processor 102. The multicore processor 102 comprises two or more processor cores 104a-104d and each of the processor cores 104a-104d may be able to simultaneously execute program code. Each of the processor cores 104a-104d may comprise functional elements for operation of the processor cores 104. An example embodiment of the multicore processor 102 is depicted in FIG. 2. For example, the processor cores may comprise microcode 105 which translates program code instructions into circuit-level operations in the processor core 104a-104d. The microcode is a set of instructions and/or tables which control how the processor core operates. The program code instructions usually are in a form of a binary code (a.k.a machine code) which has been obtained by compiling a higher level program code into binary code by a compiler. The binary code can be stored into the memory 58 from which an instruction fetcher 106 of a processor core 104 may fetch an instruction for execution by the processor core 104a-104d. The fetched instruction may be decoded by an instruction decoder 107 and the decoded instruction may be provided to an instruction executer 108 of the processor core 104a-104d which executes the decoded instruction i.e. performs the tasks the instruction indicates. In some embodiments the high level program code may not be compiled beforehand but it may be interpreted by an interpreter during a run time. The (high level) program code which is to be compiled can also be called as a source code. Also a program code written by using lower level instructions to be compiled by an assembler may also be called as a source code.

One of the processor cores of the multicore processor can be called as a first processor core, another processor core can be called as a second processor core etc. without losing generality. It is also clear that the number of processor cores may be different than four in different embodiments. For example, the multicore processor 102 may comprise two, three, five, six, seven, eight or more than eight processor cores. In the following the processor cores are generally referred by a reference number 104 but when a certain processor core is meant, the reference numbers 104a-104d may also be used for clarity.

The processor cores 104 may also comprise one or more sets of registers 110 for storing data. In the circuit level the registers may be implemented in an internal memory of the multicore processor or as internal registers. The processor cores 104 also has one or more interfaces (buses) for connecting the processor cores 104 with other circuitry of the apparatus. One interface may be provided for receiving instructions and another interface 127 may be provided for reading and/or writing data or they may use the same interface.

There may also be an address interface 128 for providing address information so that the processor cores 104 are able to fetch instructions from correct location of a program code memory and data from a data memory. In some embodiments the address interface and the data interface may be wholly or partially overlapping i.e. the same lines are used as address lines and data lines. The multicore processor may further comprise a general purpose input/output interface 129.

The multicore processor 102 may communicate with elements outside the multicore processor using these interfaces. For example, the multicore processor may provide a memory address on the address bus 138 via the address interface 128 and a read instruction on the data bus 137 via the data interface 127 wherein information stored in the addressed memory location may be read by the multicore processor, or data may be stored into the addressed memory location. In this way the processor cores 104 may read instructions and data from the memory 58 and write data to the memory 58.

The multicore processor 102 may comprise internal buses 130 for instructions, data and addresses. These buses may be shared by the processor cores 104a-104d wherein each core may access the buses one at a time, or separate buses may be provided for each of the processor cores.

The multicore processor 102 may further comprise a cache memory or cache memories for storing recently used information such as instructions and/or data. Some examples of cache memories are a level 1 (L1) cache 116, a level 2 (L2) cache 118, and/or a level 3 (L3) cache 120. In some embodiments the level 2 cache 118 and/or the level 3 cache 120 are outside the multicore processor 102, as illustrated in FIG. 2, whereas in some other embodiments they may be part of the multicore processor 102. In some instances a processor core 104 may first examine if the next instruction or data addressed by the current instruction already exist in the cache memory and if so, that instruction or data need not be fetched from the memory 58 outside of the multicore processor 102. This kind of operation may speed up the processing time of the processor core 104. FIG. 2 illustrates an example embodiment of a processor core of a multicore processor in which a set of registers 110 and three cache memories 116, 118, 120 are provided for the processor cores 104.

One or more of the processor cores 104 may also comprise other functional units FU such as an arithmetic logic unit (ALU) 124, an L1 cache 116, an L2 cache 118, an L3 cache 120, a floating point unit (FPU) 122, an instruction fetcher 106, an instruction decoder 107, an instruction executer 108, an imaging accelerator, etc.

The operation of the apparatus 100 may be controlled by an operating system (OS) 111 which is a set of sequences of instructions executable by one or more of the processor cores 104 of the multicore processor 102. In some embodiments one of the processor cores may be dedicated to the operating system or to some parts of the operating system. The operating system may comprise device drivers for controlling different elements of the apparatus 100 and/or the electronic device 50, libraries for providing certain services for computer programs so that the computer programs need not be included with instructions for performing each operation but the computer program may contain a subroutine call or other instruction which causes the multicore processor to execute the subroutine in the library when such call exists in the sequence of instructions of the computer program. For example, operations to write data on the display 32 of the electronic device 50 and/or to read data from the keypad 34 of the electronic device 50 may be provided as subroutines in a library of the operating system.

Computer programs, which may also be called as applications or software programs, comprises one or more sets of sequences of instructions to perform certain task or tasks. Computer programs may be executed as one or more threads or tasks. When the operating system executes an application or a part of it, the operating system may create a process which comprises at least one of the threads of the computer program. The threads may have a status which indicates if the thread is active, running, ready for run, waiting for an event, hold or stopped. There may also be other statuses defined for threads and, on the other hand, each thread need not have all these states mentioned. For example, threads may exist which never wait for an event.

The operating system 111 also comprises a scheduler 112 or other means for scheduling and controlling different tasks or threads of processes which are active in the apparatus 100. The scheduler 112 may be common to each processor core 104 or each processor core 104 may be provided with an own scheduler 112. One purpose of the scheduler 112 is to determine which thread of a process should next be provided processing time. The scheduler 112 may try to provide substantially the same amount of processing time for each active thread or process so that the active thread or processes would not significantly slow down or stop operating. However, there may be situations in which some threads or processes have higher priority than some other threads or processes wherein the scheduler 112 may provide more processing time to threads or processes of higher priority than threads or processes of lower priority. There may also be other reasons why each thread or process may not be provided equal processing time. For example, if a thread is waiting for an event to occur, it may not be necessary to provide processing time for that thread before the event occurs.

The scheduler 112 may be based on e.g. timer interrupts. For example, a timer 134 is programmed to generate interrupts at certain time intervals and the interrupt is detected by an interrupt module 114 of the multicore processor wherein a corresponding interrupt service routine 136 is initiated. The interrupt service routine may comprise instructions to implement the operations of the scheduler 112 or it may comprise instructions to set e.g. a flag or a semaphore which is detected by the operating system which then runs the scheduler 112.

The multicore processor 102 and the processor cores 104 may comprise other circuitry as well but they are not shown in detail here.

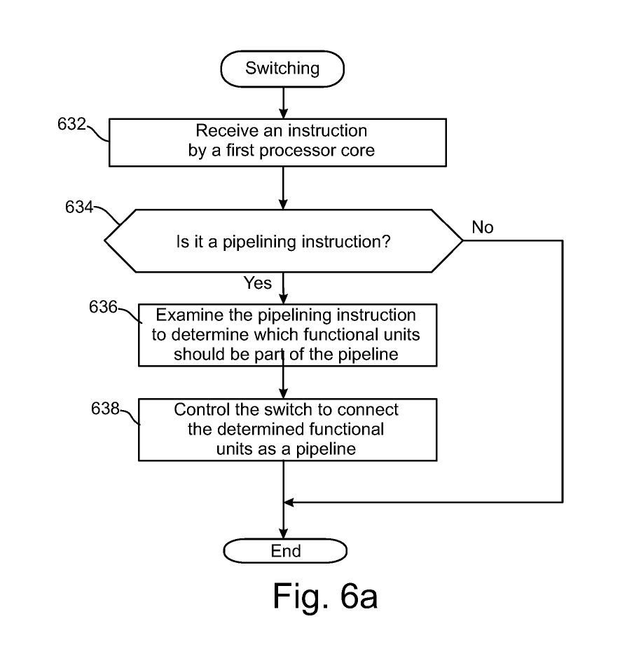

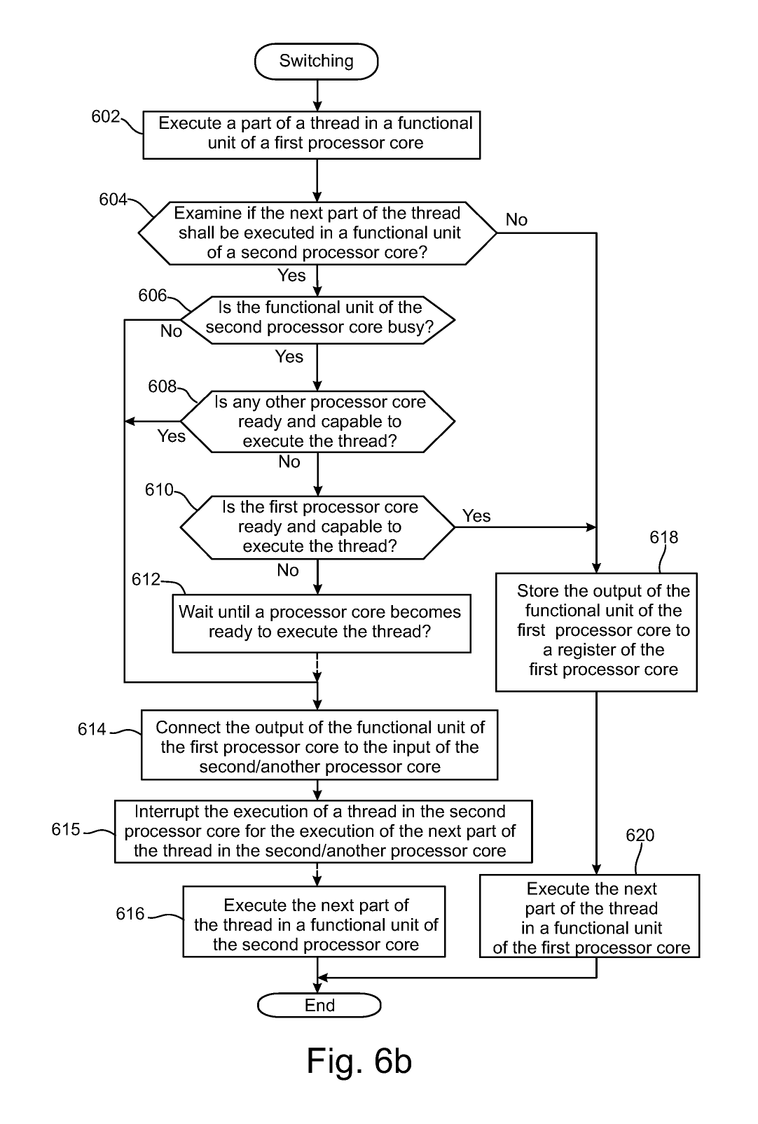

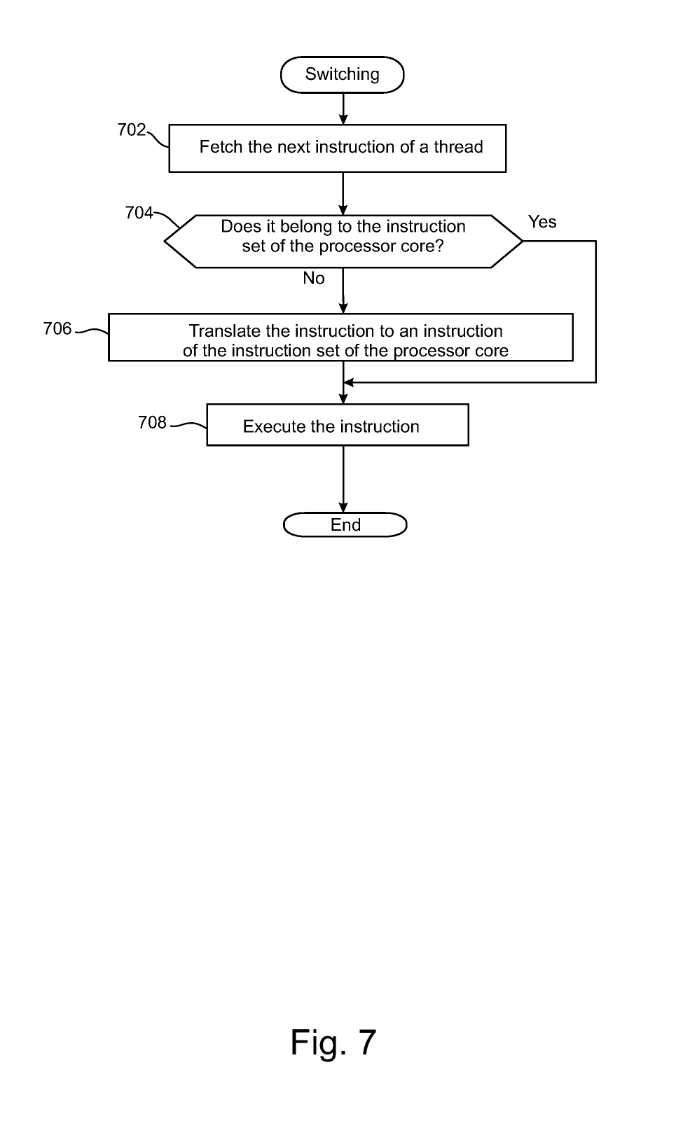

In the following the operation of the apparatus 100 is described in more detail with reference to the flow diagrams of FIGS. 6a, 6b and 7.

In some situations an active thread may not be ready for run, because the thread may have been stopped, put into a hold state or is waiting an event to occur, wherein such thread is not provided processing time. For example, a thread may be waiting for data from another thread or from another process before the thread can proceed.

In some embodiments the scheduler 112 or other part of the operating system maintains information of processing time provided for each active thread and can use this information when determining which thread should next be provided processing time. This may be implemented so that the scheduler 112 changes the status of that thread into the run state. The processor core 104 may then examine statuses of active threads and select the thread which is in the ready to run state and instructs a processor core 104 to execute instructions of that thread next.

In some embodiments of the present invention one or more functional units of two or more processor cores 104 may be arranged to operate in a pipeline manner. In other words, a process of an application can be sequentially executed in more than one processor core as will be explained in the following.

When an application is selected to be started e.g. by a user of the apparatus or as a consequence of an event occurring or a call from another program the operating system OS 111 fetches the program code or parts of it to the memory 58 so that the multicore processor 102 can start running the program. However, in some embodiments it may be possible to run the program directly from the storage in which the application has been stored i.e. without loading it first to the memory 58. The application storage may be a fixed disk, a flash disk, a compact disk (CDROM), a digital versatile disk (DVD) or another appropriate place. It may also be possible to load the application from a computer network e.g. from the internet.

The operating system also determines an entry point which contains an instruction which should be performed first. The entry point may be indicated by information stored into a so called file header of the file in which the application has been stored.

To be able to run the application it may be necessary to initialize some memory areas, parameters, variables and/or other information. The operating system may also determine and initiate one or more threads of the application. For example, the application may be a camera application which may comprise one thread for controlling the exposure time of an imaging sensor such as a charged coupled device (CCD) or a complementary metal oxide semiconductor (CMOS) sensor, one thread for reading the sensor data to the memory 58, one thread for controlling the operation and timing of a flash light, etc. When a thread is initiated a status may be defined for it. In the beginning the status may be, for example, ready for run, waiting for an event, idle etc. During the operation of the process the thread relates to the status may change. For example, the scheduler may provide some processor time for the thread wherein the status may change to run.

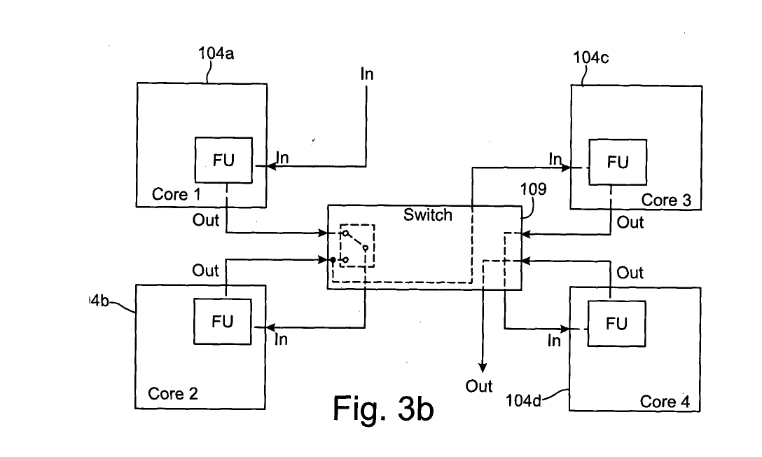

Now, an example of the scheduling of multiple threads in the multicore processor 102 will be explained in more detail with reference to FIGS. 3a to 5. It is assumed that several threads are active and running and that a certain amount of processor time shall be provided for a thread. This amount of time may also be called as a time slice or a time slot. The time slice may be constant or it may vary from time to time. Also interrupts which may occur during the operation may affect that running of a thread may be interrupted and the length of the time slice reserved for the interrupted thread may change. Furthermore, a constant length of the time slice may not mean that the length in wall clock time is constant but a constant amount of processor time may be reserved for a thread to run the thread during one time slice. In some other embodiments time slices may be kept substantially constant in length (in wall clock time) wherein an interrupt may shorten the processor time provided for an interrupted thread.

An interrupt may affect that an interrupt service routine which is attached with the interrupt in question is executed and at the beginning of the interrupt service routine the status of the interrupted thread may be stored e.g. to a stack of the processor core or to another stack of the apparatus so that the status can be retrieved when the interrupt service routine ends.

When the operating system runs the scheduler 112, the scheduler 112 determines which thread should next be provided processor time i.e. which thread should run during the next time slice. This determination may be performed for each processor core so that as many threads as there are processor cores 104 may be able to run within the same time slice. The scheduler 112 may examine the status of the active threads and select a thread for which the status indicates that it is ready for run. The scheduler 112 may also examine how much processor time threads which are ready for run have previously been provided with and select such thread which has received less processor time than some other threads. However, priorities may have been defined for the threads wherein a thread with a higher priority may receive more processor time than a thread with a lower priority. The scheduler 112 may further determine which processor core 104 should be selected for running the thread.

The scheduler 112 may also set further threads to running state so that each processor core may begin to run one thread. For example, if the multicore processor 102 comprises four processor cores 104a-104d it may be possible to run four threads at the same time. However, it may happen that there are less active threads in the ready to run state than there are processor cores 104 in the multicore processor 102. Hence, one or more of the processor cores 104 may be idle for a while.

When a thread is selected for running the scheduler 112 may change the status of the thread to running state, or the scheduler 112 may just instruct the processor core 104 selected for running the thread to retrieve the status of the thread and start to execute the instructions of the thread from the location where the running of the thread was last stopped. The scheduler 112 gives certain amount of processing time i.e. a time slice for the running thread and when the time slice ends, the thread is stopped and its status may be stored to an internal register of the processor core or to the memory 58 or to some other appropriate storage medium. In some embodiments more than one consecutive time slice may be provided for one thread wherein the thread may not be stopped after one time slice ends but the thread may run during several consecutive time slices.

In the following, the pipeline procedure according to some example embodiments will be described in more detail. It is assumed that different processor cores 104 comprise functional units which can be utilized by a thread. Such functional units may be the arithmetic logic unit (ALU), the floating point unit (FPU) 122, etc. The processor cores 104 may also comprise memory such as the L1 cache 116, the L2 cache 118, and/or the L3 cache 120. In some embodiments all the processor cores of the multicore processor 102 are substantially identical in the sense that they all comprise similar functional units, but in some other embodiments one or more of the processor cores 104 may differ from other processor cores 104 of the multicore processor 102. For example, one processor core 104 may comprise the floating point unit but the other processor cores 104 do not have any floating point units. In another example, some of the processor cores comprise level 1 cache L1 and level 2 cache L2 but the other processor cores of the multicore processor 102 only comprises level 1 cache. Therefore, some restrictions may exist when a processor core is selected for running a thread as will be explained below.

In an example embodiment one or more functional units of a processor core of the multicore processor 102 can be connected to one or more functional units of another processor core 104 of the multicore processor 102 by using a switch 109 and a specific instruction in the binary code. This kind of specific instruction is also called as a pipelining instruction in this application. The pipelining instruction may contain indication which functional units of two processor cores should be connected together so that the output of one functional unit is connected to the input of the other functional unit. When an instruction is fetched e.g. by an instruction fetcher of a processor core and decoded by an instruction decoder of the processor core (block 632 in FIG. 6a), the processor core examines 604 the instruction and if it is the pipelining instruction i.e. the pipelining instruction becomes for execution of the processor core, the processor core may examine 636 the contents of the pipelining instruction and on the basis of the contents determines which functional units should be connected to form the pipeline. The processor core may control the switch 109 to connect 638 the output of the functional unit indicated by the pipelining instruction to the input of the other functional unit. In other words, an electrical connection or another kind of connection capable to transfer data from the output to the input shall be formed. When the connection has been formed, the data may be transferred from the output to the input without intervention of a controlling element of the processor core. The binary code may include multiple corresponding pipelining instructions when the desired pipeline should comprise functional units from more than two processing cores.

In some embodiments such pipelining instruction may be provided to each processor core which contain a functional unit which shall form the pipeline.

In other words, a thread may be started in each core which may contain one instruction to connect the accelerators of different processor cores to each other as a pipeline.

In some other embodiments the whole pipeline comprising two or more processor cores of the multicore processor may be formed by using a single pipelining instruction.

When the pipeline has been constructed, a thread can be started which provides data to an input of the first functional unit of the pipeline, wherein the output of the functional unit is provided to a next functional unit. The output of the last functional unit may be written to a register, for example. There may be another thread which processes the data coming out from the pipeline.

In some embodiments the pipelining instruction or some other instruction may indicate which instructions of the binary code are such that the output formed by the instruction may not be stored to a register but is provided to the next functional unit in the pipeline.

The pipeline may also be disassembled by performing similar operations, for example, in a reversed order, e.g. by executing a special instruction in each processor core which are part of the pipeline.

FIG. 3a illustrates as a simplified block diagram of an arrangement in which the pipelining can be constructed.

In some embodiments one functional unit may exist only once in the pipeline i.e. no loops are allowed, whereas in some other embodiments a loop may be formed e.g. by using a loop counter or an element which may selectively connect the output of one functional element to the input of two or more functional units. This kind of operation may also need a corresponding element at the input of the loop so that the input can either be from a previous stage of the pipeline or from the output of the loop. This is illustrated in FIG. 3b.

The pipeline may also be dismantled e.g. by using a specific instruction which may contain indication of the connection between functional units which should be dismantled.

A camera application is used as an example implementation of the pipelining procedure according to this example embodiment. It is assumed that at least some of the processor cores comprise an imaging accelerator in which some fast imaging algorithms may have been implemented. The pipelining instruction(s) may cause that the switch 109 connects the output of the imaging accelerator of the first processor core 104a to the input of the imaging accelerator of the second processor core 104b. The same pipelining instruction or separate pipelining instructions may further cause that the switch 109 connects the output of the imaging accelerator of the second processor core 104b to the input of the imaging accelerator of the third processor core 104c, and further the output of the imaging accelerator of the third processor core 104c to the input of the imaging accelerator of the fourth processor core 104d. There may be a thread executed e.g. by the first processor core 104a which takes care of inputting data to the input of the imaging accelerator of the first processor core 104a. When the imaging accelerator of the first processor core 104a provides data at the output, the data is connected to the input of the imaging accelerator of the second processor core 104b. Correspondingly, the imaging accelerator of the second processor core 104b may output data which may then be input to the imaging accelerator of the third processor core 104c, and the imaging accelerator of the third processor core 104c may output data which may then be input to the imaging accelerator of the fourth processor core 104d. The fourth processor core 104d may execute another thread which handles the data provided by the output of the imaging accelerator of the fourth processor core 104d, for example by storing the data to the memory 58.

In the above described embodiment the execution of a thread may not be transferred from one processor core to another processor core but the data may be transferred within the pipeline without using threads.

Although in the above described example there were four processor cores involved in the pipeline and each functional unit was an imaging accelerator, the invention can also be implemented to construct pipelines using different kinds of functional units and different amounts of processor cores. It is also possible that the number of processor cores which may form the pipeline may also differ in different situations and in different embodiments. It is also possible that when a pipeline is formed only some of the processor cores belong to the pipeline. For example, if there were four processor cores, a pipeline may be constructed in such a way that it comprises two, three or four of the four processor cores.

To illustrate the pipelining principle in the multicore processor according to another example embodiment, it is assumed that a thread of a process contains floating point operations for which the floating point unit would be optimal and other calculation operations for which the arithmetic logical unit would suffice. The source code of the program may be compiled by a compiler which forms corresponding machine code. The compiler may analyse the code and determine that in a multicore processor environment some switching between processor cores may be beneficial compared to the situation that the compiler created the machine code to be run by the same processor core. Then, the compiler could include a specific instruction or a sequence of instructions which would affect that a pipeline is formed between one processor core and another processor core. For example, the operations for which the arithmetic logical unit is sufficient would be addressed to a first processor core and when floating point operations are to be performed the switching instruction is added to the binary code so that the floating point operations shall be performed by a second processor core which has the floating point unit. In that way a pipeline of functional units of different processor cores may be created in the binary code level.

When the binary code of such thread is run by the multicore processor 102 the scheduler 112 gives processing time to the thread (this is illustrated with block 602 in FIG. 6b). The binary code of the thread may contain an instruction which indicates 604 the processor core which should execute the following instructions of binary code of the thread. The instruction initiates the switch 109 so that the scheduler 112 or another element of the operating system may check 606 whether the indicated processor core is busy or is ready for running the thread. If the scheduler 112 determines that the indicated processor core 104 is ready for running the thread, the scheduler 112 instructs the processor core to run 616 the thread (or at least to begin to run a part of the thread). In some embodiments this is preceded with connecting 614 the output of the functional unit of the switching-from processor core to an input of a functional unit of the switching-to processor core. Otherwise, If the scheduler 112 determines that the indicated processor core 104 is not ready for running the thread, the scheduler 112 may examine 608 the status of one or more of the other processor cores and if any of them is ready to run the thread, the scheduler 112 may select that processor core. However, if some of the processor cores which are ready to run the thread is not applicable to run the current part of the thread (e.g. the processor core 104 does not comprise applicable functional unit which may be needed by the thread) the scheduler 112 may not select such processor core. If there is not any processor core 104 which is ready and applicable to run the current part of the thread the scheduler 112 may not select any of the processor cores 104 and sets or maintains the thread in the ready to run state waiting 612 that a processor core becomes ready to run the thread, or the scheduler 112 may select 610 the same processor core to continue 620 the execution of the thread. The scheduler 112 may occasionally or periodically examine the status of the processor cores 104 and when the scheduler 112 determines that one processor core 104 becomes available for the thread, the scheduler 112 may proceed by instructing that processor core 104 to run the current part of the thread.

If the scheduler 112 selects the same processor core 104 which executed the previous part of the thread i.e. the processor core continues to execute the thread, there may be a need to store 618 the output of the functional unit to a register or to a memory.

When the scheduler 112 selects another processor core 104 than the processor core indicated by the binary code, there may be a need to translate instructions of the binary code to instructions according to the instruction set of the other processor core 104. This will be explained later in this specification.

In some other embodiments the scheduler 112 may perform at least some of the tasks of the switch wherein the scheduler 112 may inter alia check whether the indicated processor core is busy or is ready for running the thread. In this case, the switch 109 may perform the connection of the internal buses to enable the switching-from processor block provide the output of the functional unit to an input of a functional unit of the switching-to processor core.

When the selected processor core 104 starts to run the current part of the thread it fetches the next instruction or a block of instructions from the memory 58 or from a cache L1, L2 or L3, if these instructions have previously been loaded to the cache. The processor core 104 may continue to run the thread until the scheduler 112 informs that the time slice has ended wherein the current context of the thread may be stored to a context buffer, for example. The context of a thread may include the value of a program counter, values of registers used by the thread, contents of a stack of the thread, etc.

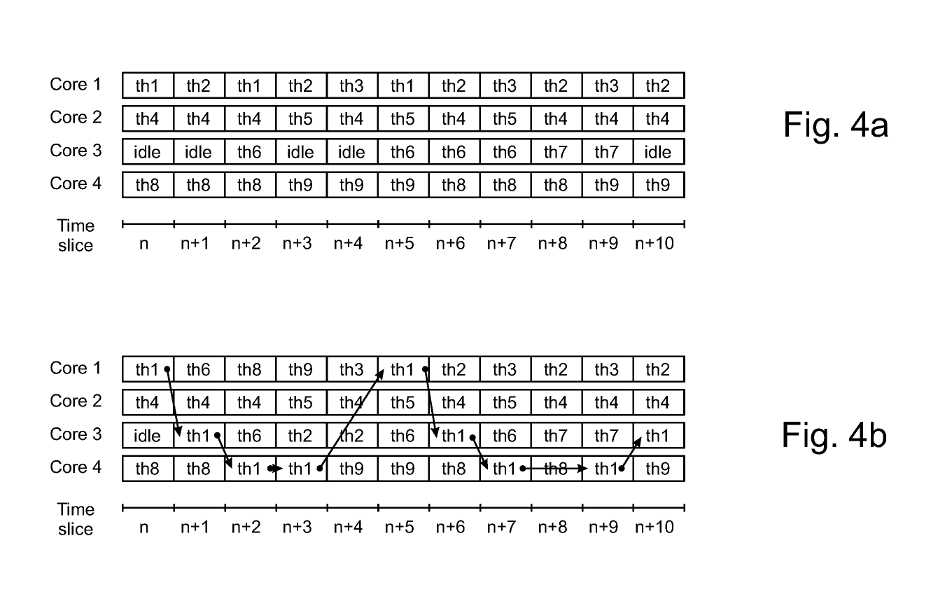

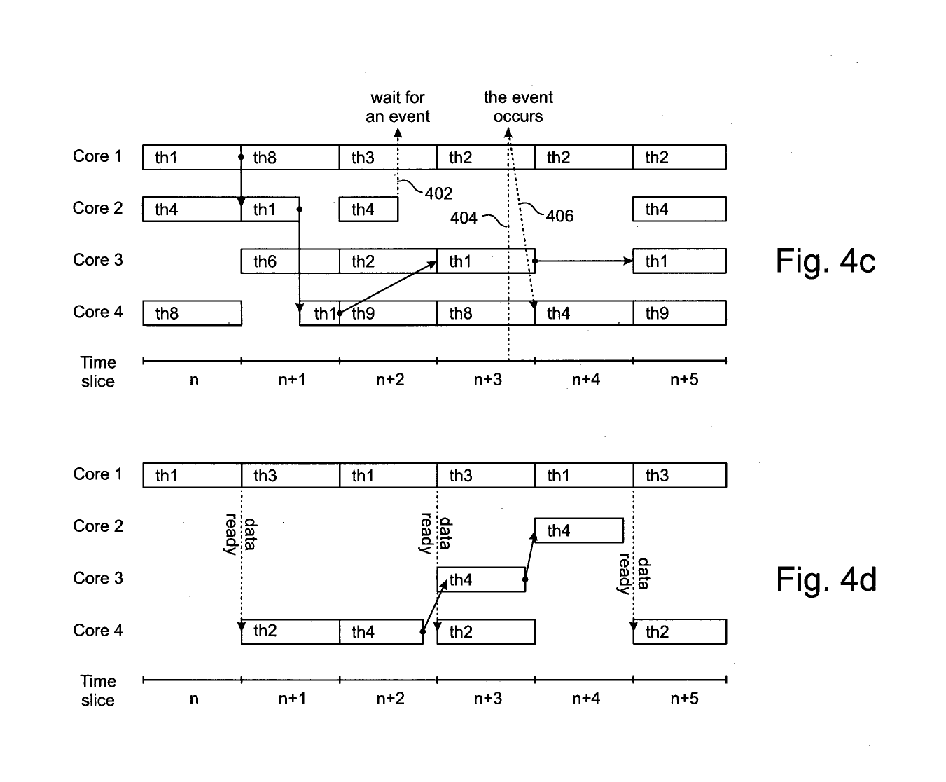

FIG. 4a depicts an example of some time slices and running of different threads th1-th9 in different processor cores 104a-104d (core 1, core 2, core 3 and core 4). In this example it is assumed that no pipelining occurs between different processor cores but each thread is run in the same processor core. The text “idle” indicates a time slice in which that processor core is not running a thread.

FIG. 4b depicts another example of some time slices and running of different threads th1-th9 in different processor cores 104a-104d in such a way that pipelining between processor cores is in use wherein the scheduler 112 may change threads between processor cores. For example, the thread th1 is first run by the first core, then the next part of the thread is run by the third processor core and after that the fourth processor core continues to run the thread etc. The arrows in FIG. 4b illustrate the switching of processor cores.

The switching of the processor core 104 may also occur within a time slice as is depicted in FIG. 4c. In FIG. 4c the empty time slices indicate idle time slices of the processor cores.

FIG. 4c also depicts an example in which a thread (th4) moves to the state in which it begins to wait an event occurring before the thread continues to run. This moment is illustrated with the arrow 402. When the event has occurred (arrow 404) the thread may continue to run at the beginning of the next time slice. In this example the processing core is also changed i.e. the thread is moved to run in another processor core (arrow 406).

FIG. 4d depicts an example in which a first thread (th1) is executed by the first processor core 104a to input data to the pipeline and a second thread th2 is executed by the fourth processor core 104d to read the data from the pipeline for further processing. There may also be other threads th3, th4 running in the processor cores 104.

In some embodiments of the present invention the switching may comprise at least the following. The processor core 104 from which the switching occurs (a switching-from processor core) may not store the results of the operation of the functional block in that processor core 104 into the memory 58 but the processor core 104 provides the results to the processor core 104 which continues the running of the thread (a switching-to processor core). The switching-to processor core uses the results as an input of a functional block of the processor core 104. For example, if the switching-from processor core calculated a floating point multiplication, the multiplication result may be provided to an arithmetic logical unit of the switching-to processor core to e.g. add a value to the multiplication result. The results may be provided by the switching-from processor core to the switching-to processor core by using internal registers or other internal memory of the multicore processor which is shared by processor cores of the multicore processor. It may also be possible to use some of the internal buses of the multicore processor 102 for providing the results from one processor core to another processor core. In some embodiments the special instruction contains indication on the buses or lines of the internal buses 130 which connect the output(s) of the originating functional unit of the switching-from processor core to the input(s) of the destined functional unit of the switching-to processor core. The switching between processor cores may be faster by using the internal buses, internal registers or internal memory than by using a memory outside the multicore processor 102.

In the above it was assumed that the switching-from processor core and the switching-to processor core have similar instruction sets wherein the same binary code can be run by both processor cores. However, in some embodiments there may be differences in instruction sets between processor cores of the multicore processors. Hence, it may not be so straightforward task to perform the switching operation. In some example embodiments the switching between processor cores of different instruction sets may be performed as follows.

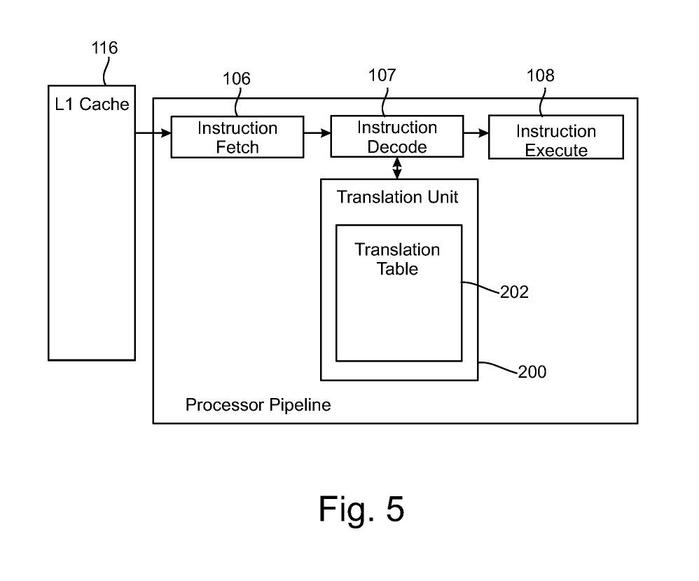

The binary code of the process may have been compiled by using a compiler which creates binary code according to the instruction set of one of the processor cores of the multicore processor. Let us assume as an example that the binary code is compatible with the instruction set of a first processor core 104a and that the thread is running in the first processor core 104a. It may also be assumed that a second processor core 104b has an instruction set which is different from the instruction set of the first processor core 104a. When the processing has proceeded to an instruction which initiates a switch from the first processor core 104a to the second processor core 104b, the scheduler 112 activates and instructs the second processor core 104b to continue the running of the thread. The instruction fetcher 106 of the second processor core 104b fetches the next instruction from the program memory (or from the cache, if the instruction exist in the cache). The instruction is provided to the instruction decoder 107 which may determine that this instruction is not in the instruction set of the second processor core. Therefore, the instruction decoder 107 provides the instruction to a translation unit 200 (FIG. 5) which translates the instruction to a corresponding instruction or a sequence of instructions of the instruction set of the second processor core 104b. The translated instruction or sequence of instructions is provided to the instruction executer 108 which executes the instruction. The translation unit 200 may use a translation table 202 for the instruction translation.

In some example embodiments the translation table 202 may be constructed as follows. One column of the translation table comprises instructions of the first processor core 104a and another column comprises corresponding instructions or sequences of instructions of the second processor core 104b. Also other possibilities exist to implement the translation between instruction sets. The translation table may also be writeable wherein new translations of instructions may be added e.g. if a new processor core is added to the system.

The translation unit 200 may be provided in each processor core 104 of the multicore processor 102 or only in one or some of the processor cores 104. For example, if the multicore processor 102 comprises four processor cores 104a-104d each of which has at least partly different instruction set, it may be sufficient to provide the translation unit 200 to three of the four processor units. In this case the binary code might be comprise instructions which belong to the instruction set of that processor core which does not have the translation unit 200. In another embodiment the multicore processor 102 could comprise six processor cores each of which has the translation unit 200 but e.g. four of the processor cores have similar instruction sets. Hence, the binary code stored to the program memory might correspond with the instruction set which is common to the majority of the processor cores.

When this kind of an arrangement is utilised there is no need to compile and store the binary code of the process for each instruction set of the multicore processor but it may suffice to only provide one binary code which may then be translated by the translation units 200 of the processor cores of the multicore processor.

The translation units 200 can also be implemented in multicore processors 102 in which the pipelining of functional units of different processor cores is not used. It is still possible to change the processor core which is used to run a thread e.g. by the scheduler 112. For example, the scheduler 112 may determine which processor core might be selected to execute a thread which is ready for running. If the selected processor core has different instruction set than the binary code of the thread, the processor core uses the translation unit 200 to translate the instructions of the thread to corresponding instructions which belong to the instruction set of the selected processor core.

It may also happen that when a thread is run by e.g. the first processor core 104a another process or thread is initiated which should be run or which would most efficiently be run by the same first processor core 104a. Then, at the end of the current time slice (or at the beginning of the next time slice) the scheduler 112 might determine that the initiated thread should be run by the first processor core 104a which was reserved to the previously initiated thread. The scheduler 112 may then address another processor core 104b-104d, e.g. the second processor core 104b for the previously initiated thread and use the first processor core 104a to run the later initiated thread.

It may also happen that when a pipeline is formed between a functional unit of e.g. the first processor core 104a and a functional unit of the second processor core 104b, another process or thread is initiated which should be run or which would most efficiently be run in the same functional unit which is part of the pipeline. Hence, in some embodiments the processor core 104 in which this situation occurs, may use other functional element(s) instead to execute the another thread. Then, the translation unit 200 may translate the instructions of the thread to enable the execution of the thread by the other functional unit. For example, if the processor core 104 comprises a fast fourier transform calculation unit and it is part of the existing pipeline, and the another thread includes instructions for calculation of a fast fourier transform by the fast fourier transform calculation unit, the translation unit 200 may translate the binary code to conduct the fast fourier transform calculation by another functional unit(s) of the processor core 104.

In some embodiments it may also occur that the scheduler 112 may determine that a part of an active thread should be run by a certain processor core instead of the processor core which may have been selected by the compiler in the binary code of the thread. Hence, the scheduler 112 may insert a switching instruction or use other means to effect the switching from one processor core to another processor core.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the apparatus, such as in the pro-cesssor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of exemplary embodiments of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following some example embodiments will be provided.

According to some example embodiments there is provided a method comprising:
receiving a pipelining instruction by a first processor core of a multicore processor;
using information in the pipelining instruction to determine a connection between a first functional unit in the first processor core and a second functional unit in a second processor core of the multicore processor; and
controlling a switch to form a pipeline comprising the first functional unit and the second functional unit to enable data communication connection between an output of the first functional unit and an input of the second functional unit.

In some embodiments the method comprises controlling the switch to couple the output of the first functional unit to the input of the second functional unit.

In some embodiments the method comprises connecting the output of the first functional unit to the input of the second functional unit via an internal bus of the multicore processor.

In some embodiments the method comprises controlling the switch to form the communication connection via an internal register of the multicore processor.

In some embodiments the method comprises using a cache memory of the multicore processor as the internal memory.

In some embodiments the pipelining instruction comprises indication of the first functional unit and the second functional unit.

In some embodiments the method comprises using information in the pipelining instruction to add a third functional unit in a third processor core of the multicore processor to the pipeline.

In some embodiments the method comprises receiving another pipelining instruction to add a third functional unit in a third processor core of the multicore processor to the pipeline.

In some embodiments the method comprises:
receiving a set of instructions of a thread to use the first functional unit;
examining whether the first functional unit is part of the pipeline;
if so, translating the set of instructions of the thread to perform the tasks of the set of instructions of the thread by one or more other functional units in the first processor core.

In some embodiments the method comprises using a translation table in the translation.

In some embodiments the method comprises:
running a first sequence of instructions of a thread in the first processor core;
obtaining a result by the first sequence of instructions of the thread;
providing the result from the first processor core to the second processor core as an input to a second sequence of instructions of the thread; and
running the second sequence of instructions of the thread in the second processor core.

In some embodiments the method comprises:
using the first functional unit when running the first sequence of instructions of the thread; and
using the second functional unit when running the second sequence of instructions of the thread.

In some embodiments the method comprises:
examining whether the second processor core is running another thread;
pre-empting the execution of the other thread, if the examining indicates that the second processor core is running the other thread; and
switching the execution of the thread to the second processor core.

In some embodiments the first sequence of instructions and the second sequence of instructions comprise instructions of an instruction set of the first processor core.

In some embodiments at least part of the instructions of the instruction set of the first processor core differ from instructions of an instruction set of the second processor core.

In some embodiments running the second sequence of instructions of the thread in the second processor core comprises translating instructions of the second sequence of the thread which do not belong to the instruction set of the second processor core to instructions of the instruction set of the second processor core.

In some embodiments the method comprises using a translation table in the translation.

In some embodiments the method comprises using the multicore processor as a component of a mobile terminal.

According to some example embodiments there is provided an apparatus comprising at least one processor and at least one memory including computer program code, the at least one memory and the computer program code configured to, with the at least one processor, cause the apparatus to:
receive a pipelining instruction by a first processor core of a multicore processor;
use information in the pipelining instruction to determine a connection between a first functional unit in the first processor core and a second functional unit in a second processor core of the multicore processor; and
control a switch to form a pipeline comprising the first functional unit and the second functional unit to enable data communication connection between an output of the first functional unit and an input of the second functional unit.

In some embodiments said at least one memory stored with code thereon, which when executed by said at least one processor, further causes the apparatus to control the switch to couple the output of the first functional unit to the input of the second functional unit.

In some embodiments said at least one memory stored with code thereon, which when executed by said at least one processor, further causes the apparatus to connect the output of the first functional unit to the input of the second functional unit via an internal bus of the multicore processor.

In some embodiments said at least one memory stored with code thereon, which when executed by said at least one processor, further causes the apparatus to control the switch to form the communication connection via an internal register of the multicore processor.

In some embodiments said at least one memory stored with code thereon, which when executed by said at least one processor, further causes the apparatus to use a cache memory of the multicore processor as the internal memory.

In some embodiments the pipelining instruction comprises indication of the first functional unit and the second functional unit.

In some embodiments said at least one memory stored with code thereon, which when executed by said at least one processor, further causes the apparatus to use information in the pipelining instruction to add a third functional unit in a third processor core of the multicore processor to the pipeline.

In some embodiments said at least one memory stored with code thereon, which when executed by said at least one processor, further causes the apparatus to receive another pipelining instruction to add a third functional unit in a third processor core of the multicore processor to the pipeline.

In some embodiments said at least one memory stored with code thereon, which when executed by said at least one processor, further causes the apparatus to:
receive a set of instructions of a thread to use the first functional unit;
examine whether the first functional unit is part of the pipeline;
translate the set of instructions of the thread to perform the tasks of the set of instructions of the thread by one or more other functional units in the first processor core, if the first functional unit is part of the pipeline.

In some embodiments said at least one memory stored with code thereon, which when executed by said at least one processor, further causes the apparatus to use a translation table in the translation.

In some embodiments said at least one memory stored with code thereon, which when executed by said at least one processor, further causes the apparatus to:
run a first sequence of instructions of a thread in a first processor core of the multicore processor;
obtain a result by the first sequence of instructions of the thread;
provide the result from the first processor core to the second processor core as an input to a second sequence of instructions of the thread; and
run the second sequence of instructions of the thread in the second processor core.

In some embodiments said at least one memory stored with code thereon, which when executed by said at least one processor, further causes the apparatus to:
use the first functional unit when running the first sequence of instructions of the thread; and
use the second functional unit when running the second sequence of instructions of the thread.

In some embodiments said at least one memory stored with code thereon, which when executed by said at least one processor, further causes the apparatus to:
examine whether the second processor core is running another thread;
pre-empt the execution of the other thread, if the examining indicates that the second processor core is running the other thread; and
switch the execution of the thread to the second processor core.

In some embodiments the first sequence of instructions and the second sequence of instructions comprises instructions of an instruction set of the first processor core.

In some embodiments at least part of the instructions of the instruction set of the first processor core differ from instructions of an instruction set of the second processor core.

In some embodiments said at least one memory stored with code thereon, which when executed by said at least one processor, further causes the apparatus to translate instructions of the second sequence of the thread which do not belong to the instruction set of the second processor core to instructions of the instruction set of the second processor core.

In some embodiments said at least one memory stored with code thereon, which when executed by said at least one processor, further causes the apparatus to use a translation table in the translation.

In some embodiments the multicore processor is a component of a mobile terminal.

According to some example embodiments there is provided computer program product including one or more sequences of one or more instructions which, when executed by one or more processors, cause an apparatus to at least perform the following:
receive a pipelining instruction by a first processor core of a multicore processor;
use information in the pipelining instruction to determine a connection between a first functional unit in the first processor core and a second functional unit in a second processor core of the multicore processor; and
control a switch to form a pipeline comprising the first functional unit and the second functional unit to enable data communication connection between an output of the first functional unit and an input of the second functional unit.

In some embodiments the computer program product includes one or more sequences of one or more instructions which, when executed by one or more processors, cause the apparatus to at least perform the following:
control the switch to couple the output of the first functional unit to the input of the second functional unit.

In some embodiments the computer program product includes one or more sequences of one or more instructions which, when executed by one or more processors, cause an apparatus to at least perform the following:
connect the output of the first functional unit to the input of the second functional unit via an internal bus of the multicore processor.

In some embodiments the computer program product includes one or more sequences of one or more instructions which, when executed by one or more processors, cause an apparatus to at least perform the following:

control the switch to form the communication connection via an internal register of the multicore processor.

In some embodiments the computer program product includes one or more sequences of one or more instructions which, when executed by one or more processors, cause an apparatus to at least perform the following:

use a cache memory of the multicore processor as the internal memory.

In some embodiments the pipelining instruction comprises indication of the first functional unit and the second functional unit.

In some embodiments the computer program product includes one or more sequences of one or more instructions which, when executed by one or more processors, cause an apparatus to at least perform the following:
use information in the pipelining instruction to add a third functional unit in a third processor core of the multicore processor to the pipeline.

In some embodiments the computer program product includes one or more sequences of one or more instructions which, when executed by one or more processors, cause an apparatus to at least perform the following:
receive another pipelining instruction to add a third functional unit in a third processor core of the multicore processor to the pipeline.

In some embodiments the computer program product includes one or more sequences of one or more instructions which, when executed by one or more processors, cause an apparatus to at least perform the following:
receive a set of instructions of a thread to use the first functional unit; examine whether the first functional unit is part of the pipeline;
translate the set of instructions of the thread to perform the tasks of the set of instructions of the thread by one or more other functional units in the first processor core, if the first functional unit is part of the pipeline.

In some embodiments the computer program product includes one or more sequences of one or more instructions which, when executed by one or more processors, cause an apparatus to at least perform the following:
use a translation table in the translation.

In some embodiments the computer program product includes one or more sequences of one or more instructions which, when executed by one or more processors, cause an apparatus to at least perform the following:
run a first sequence of instructions of a thread in the first processor core;
obtain a result by the first sequence of instructions of the thread;
provide the result from the first processor core to the second processor core as an input to a second sequence of instructions of the thread; and
run the second sequence of instructions of the thread in the second processor core.

In some embodiments the computer program product includes one or more sequences of one or more instructions which, when executed by one or more processors, cause an apparatus to at least perform the following:
use the first functional unit when running the first sequence of instructions of the thread; and
use the second functional unit when running the second sequence of instructions of the thread.

In some embodiments the computer program product includes one or more sequences of one or more instructions which, when executed by one or more processors, cause an apparatus to at least perform the following:
examine whether the second processor core is running another thread;
pre-empt the execution of the other thread, if the examining indicates that the second processor core is running the other thread; and
switch the execution of the thread to the second processor core.

In some embodiments the first sequence of instructions and the second sequence of instructions comprise instructions of an instruction set of the first processor core.

In some embodiments at least part of the instructions of the instruction set of the first processor core differ from instructions of an instruction set of the second processor core.

In some embodiments the computer program product includes one or more sequences of one or more instructions which, when executed by one or more processors, cause an apparatus to at least perform the following:
translate instructions of the second sequence of the thread which do not belong to the instruction set of the second processor core to instructions of the instruction set of the second processor core.

In some embodiments the computer program product includes one or more sequences of one or more instructions which, when executed by one or more processors, cause an apparatus to at least perform the following:
use a translation table in the translation.

In some embodiments the computer program product includes one or more sequences of one or more instructions which, when executed by one or more processors, cause an apparatus to at least perform the following:
use the multicore processor as a component of a mobile terminal.

According to some example embodiments there is provided an apparatus comprising:
a multicore processor comprising at least a first processor core and a second processor core;
an instruction decoder adapted to receive a pipelining instruction by the first processor core of the multicore processor, wherein the first processor core is adapted to use information in the pipelining instruction to determine a connection between a first functional unit in the first processor core and a second functional unit in a second processor core of the multicore processor; and
a switch adapted to form a pipeline comprising the first functional unit and the second functional unit to enable data communication connection between an output of the first functional unit and an input of the second functional unit.

In some embodiments the apparatus is a component of a mobile terminal.

According to some example embodiments there is provided an apparatus comprising:
means for receiving a pipelining instruction by a first processor core of a multicore processor;
means for using information in the pipelining instruction to determine a connection between a first functional unit in the first processor core and a second functional unit in a second processor core of the multicore processor; and
means for controlling a switch to form a pipeline comprising the first functional unit and the second functional unit to enable data communication connection between an output of the first functional unit and an input of the second functional unit.

In some embodiments the apparatus comprises means for controlling the switch to couple the output of the first functional unit to the input of the second functional unit.

In some embodiments the apparatus comprises means for connecting the output of the first functional unit to the input of the second functional unit via an internal bus of the multicore processor.

In some embodiments the apparatus comprises means for controlling the switch to form the communication connection via an internal register of the multicore processor.

In some embodiments the apparatus comprises means for using a cache memory of the multicore processor as the internal memory.

In some embodiments the pipelining instruction comprises indication of the first functional unit and the second functional unit.

In some embodiments the apparatus comprises means for using information in the pipelining instruction to add a third functional unit in a third processor core of the multicore processor to the pipeline.

In some embodiments the apparatus comprises means for receiving another pipelining instruction to add a third functional unit in a third processor core of the multicore processor to the pipeline.

In some embodiments the apparatus comprises:
means for receiving a set of instructions of a thread to use the first functional unit;
means for examining whether the first functional unit is part of the pipeline;

means for translating the set of instructions of the thread to perform the tasks of the set of instructions of the thread by one or more other functional units in the first processor core, if the first functional unit is part of the pipeline.

In some embodiments the apparatus comprises a translation table for the translation.

In some embodiments the apparatus comprises:
means for running a first sequence of instructions of a thread in a first processor core of a multicore processor;
means for obtaining a result by the first sequence of instructions of the thread;
means for providing the result from the first processor core to a second processor core of the multicore processor as an input to a second sequence of instructions of the thread;
means for running the second sequence of instructions of the thread in the second processor core.

In some embodiments the apparatus comprises:
means for using a first functional unit in the first processor core when running the first sequence of instructions of the thread; and
means for using a second functional unit in the second processor core when running the second sequence of instructions of the thread.

In some embodiments the apparatus comprises:
means for examining whether the second processor core is running another thread;
means for pre-empting the execution of the other thread, if the examining indicates that the second processor core is running the other thread;
means for switching the execution of the thread to the second processor core.

In some embodiments the first sequence of instructions and the second sequence of instructions comprise instructions of an instruction set of the first processor core.

In some embodiments at least part of the instructions of the instruction set of the first processor core differ from instructions of an instruction set of the second processor core.

In some embodiments the means for running the second sequence of instructions of the thread in the second processor core comprise means for translating instructions of the second sequence of the thread which do not belong to the instruction set of the second processor core to instructions of the instruction set of the second processor core.

In some embodiments the apparatus comprises means for using a translation table in the translation.

In some embodiments the apparatus comprises means for using the multicore processor as a component of a mobile terminal.

1-73. (canceled)

74. A method comprising:
receiving a pipelining instruction by a first processor core of a multicore processor;
using information in the pipelining instruction to determine a connection between a first functional unit in the first processor core and a second functional unit in a second processor core of the multicore processor; and
controlling a switch to form a pipeline comprising the first functional unit and the second functional unit to enable data communication connection between an output of the first functional unit and an input of the second functional unit.

75. The method according to claim 74 comprising controlling the switch to couple the output of the first functional unit to the input of the second functional unit.

76. The method according to claim 75 comprising connecting the output of the first functional unit to the input of the second functional unit via an internal bus of the multicore processor.

77. The method according to claim 74 comprising controlling the switch to form the communication connection via an internal register of the multicore processor.

78. The method according to claim 74 comprising:
running a first sequence of instructions of a thread in the first processor core;
obtaining a result by the first sequence of instructions of the thread;
providing the result from the first processor core to the second processor core as an input to a second sequence of instructions of the thread; and
running the second sequence of instructions of the thread in the second processor core.

79. The method according to claim 78, wherein at least part of the instructions of the instruction set of the first processor core differ from instructions of an instruction set of the second processor core.

80. The method according to claim 79, wherein running the second sequence of instructions of the thread in the second processor core comprises translating instructions of the second sequence of the thread which do not belong to the instruction set of the second processor core to instructions of the instruction set of the second processor core.

81. The method according to claim 80 comprising using one pipelining instruction to form the whole pipeline comprising two or more processor cores of the multicore processor.

82. The method according to claim 74 comprising using the multicore processor as a component of a mobile terminal.

83. An apparatus comprising at least one processor and at least one memory including computer program code, the at least one memory and the computer program code configured to, with the at least one processor, cause the apparatus to:
receive a pipelining instruction by a first processor core of a multicore processor;
use information in the pipelining instruction to determine a connection between a first functional unit in the first processor core and a second functional unit in a second processor core of the multicore processor; and
control a switch to form a pipeline comprising the first functional unit and the second functional unit to enable data communication connection between an output of the first functional unit and an input of the second functional unit.

84. The apparatus according to claim 83, said at least one memory stored with code thereon, which when executed by said at least one processor, further causes the apparatus to control the switch to couple the output of the first functional unit to the input of the second functional unit.

85. The apparatus according to claim 84, said at least one memory stored with code thereon, which when executed by said at least one processor, further causes the apparatus to connect the output of the first functional unit to the input of the second functional unit via an internal bus of the multicore processor.

86. The apparatus according to claim 83, said at least one memory stored with code thereon, which when executed by said at least one processor, further causes the apparatus to control the switch to form the communication connection via an internal register of the multicore processor.

87. The apparatus according to claim 86, said at least one memory stored with code thereon, which when executed by said at least one processor, further causes the apparatus to use a cache memory of the multicore processor as the internal memory.

88. The apparatus according to claim 83, said at least one memory stored with code thereon, which when executed by said at least one processor, further causes the apparatus to:
run a first sequence of instructions of a thread in the first processor core of the multicore processor;
obtain a result by the first sequence of instructions of the thread;
provide the result from the first processor core to the second processor core of the multicore processor as an input to a second sequence of instructions of the thread; and
run the second sequence of instructions of the thread in the second processor core.

89. The apparatus according to claim 88, wherein at least part of the instructions of the instruction set of the first processor core differ from instructions of an instruction set of the second processor core.

90. The apparatus according to claim 89, said at least one memory stored with code thereon, which when executed by said at least one processor, further causes the apparatus to translate instructions of the second sequence of the thread which do not belong to the instruction set of the second processor core to instructions of the instruction set of the second processor core.

91. The apparatus according to claim 83, wherein the multicore processor is a component of a mobile terminal.

92. An apparatus comprising:
a multicore processor comprising at least a first processor core and a second processor core;
an instruction decoder adapted to receive a pipelining instruction by the first processor core of the multicore processor, wherein the first processor core is adapted to use information in the pipelining instruction to determine a connection between a first functional unit in the first processor core and a second functional unit in a second processor core of the multicore processor; and
a switch adapted to form a pipeline comprising the first functional unit and the second functional unit to enable data communication connection between an output of the first functional unit and an input of the second functional unit.

93. An apparatus comprising:
means for receiving a pipelining instruction by a first processor core of a multicore processor;
means for using information in the pipelining instruction to determine a connection between a first functional unit in the first processor core and a second functional unit in a second processor core of the multicore processor; and
means for controlling a switch to form a pipeline comprising the first functional unit and the second functional unit to enable data communication connection between an output of the first functional unit and an input of the second functional unit.
